(19) United States
(12) Patent Application Publication
(10) Pub. No.: US 2020/0288403 A1
(43) Pub. Date: Sep. 10, 2020

(54) SMART POWER SAVING METHOD FOR TERMINAL, TERMINAL, AND DEVICE HAVING MEMORY FUNCTION

(71) Applicant: JRD COMMUNICATION (SHENZHEN) LTD., SHENZHEN (CN)

(72) Inventors: ZHAOYUN WU, SHENZHEN (CN); HUIXIN WANG, SHENZHEN (CN); YAN FANG, SHENZHEN (CN); LONGQUAN YUAN, SHENZHEN (CN); ZILONG HE, SHENZHEN (CN); WEILONG ZHOU, SHENZHEN (CN)

(21) Appl. No.: 16/880,961

(22) Filed: May 21, 2020

Related U.S. Application Data
(63) Continuation of application No. PCT/CN2018/119783, filed on Dec. 7, 2018.

(30) Foreign Application Priority Data
Dec. 7, 2017 (CN) 201711307013.3

(51) Int. Cl. H04W 52/02; H04L 29/12

(52) U.S. Cl. CPC H04W 52/0251; H04W 84/12; H04L 61/2053; H04L 61/2015

(57) ABSTRACT

The present disclosure discloses a smart power saving method for a terminal. The method may include: acquiring an IP lease duration corresponding to an IP address of a Wi-Fi connection with the terminal; determining whether the IP lease duration is not larger than a preset threshold; determining whether a screen of the terminal is in a screen-off state or whether a CPU of the terminal is in a sleep state; and if the screen of the terminal is in the screen-off state or the CPU of the terminal is in the sleep state, and the IP lease duration is not larger the preset threshold, removing a first lease process.

### CROSS REFERENCE

The present application is a continuation-application of International (PCT) Patent Application No. PCT/CN2018/119783, filed on Dec. 7, 2018, which claims foreign priority of Chinese Patent Application No. 201711307013.3, filed on Dec. 7, 2017, in the National Intellectual Property Administration of China, the entire contents of which are hereby incorporated by reference in its entirety.

### TECHNICAL FIELD

The present disclosure relates to the field of communications, in particular to a smart power saving method for a terminal, a terminal and a device with memory function.

### BACKGROUND

With the development of wireless network, more and more device users use Wi-Fi to access the network. How to reduce Wi-Fi power consumption without affecting user experience has become a focus of power optimization for terminal devices. During Wi-Fi connection, the terminal will acquire an IP address from a router through DHCP (Dynamic Host Configuration Protocol). Since the IP address has a lease duration, according to the DHCP specification, the terminal renews the lease of the IP address at regular intervals. Renewal time points include Renew and Rebind. The Renew process is generally half of the current lease duration, whereas the Rebind is at the end of the current lease duration. However, when the screen is off and the lease is short, the setting will cause application processor and Wi-Fi to be woken up frequently, thereby causing an increase in power consumption.

### SUMMARY OF THE DISCLOSURE

The technical scheme according to the present disclosure is to provide a smart power saving method for a terminal, including operations as followed.

acquiring an IP lease duration corresponding to an IP address of a Wi-Fi connection with a terminal:

determining whether the IP lease duration is not larger than a preset threshold;

determining whether a screen of the terminal is in a screen-off state or whether a CPU of the terminal is in a sleep state;

when the screen of the terminal is in the screen-off state or the CPU of the terminal is in the sleep state, and the IP lease duration is not larger than the preset threshold, removing a first lease process.

Another technical scheme according to the present disclosure is to provide a terminal, including a processor and a memory electrically connected to the processor, wherein the method is executed when the processor is in operation, and the memory stores a result of the execution of the processor and a program data of the smart power saving method for the terminal.

Another technical scheme according to the present disclosure is to provide a device having a memory function, wherein the memory device stores the program data. The program data is executed to achieve the smart power saving method for the terminal.

### BRIEF DESCRIPTION OF THE DRAWINGS

To further illustrate technical solutions of embodiments of the present disclosure, drawings needed for description of the embodiments will be briefly introduced. Obviously, the following drawings are only some embodiments of the present disclosure. To any one of skill in the art, other drawings may be obtained without any creative work based on the following drawings.

FIG. 1 is a flow schematic view of a smart power saving method for a terminal according to an embodiment of the present disclosure,

FIG. 2 is a structural schematic view of a terminal according to an embodiment of the present disclosure;

FIG. 3 is a structural schematic view of a device having a memory function according to an embodiment of the present disclosure.

### DETAILED DESCRIPTION

Referring to the accompanying drawings, the embodiments of the present disclosure will be described. With consideration of clarity and brevity, the function and construction of public knowledge will not be described in detail. The terms described below may be qualified by the functions mentioned in the present disclosure, and may vary according to the intent or implementation of users and operators. Therefore, the terms should be qualified on the basis of the disclosure of the entire specification.

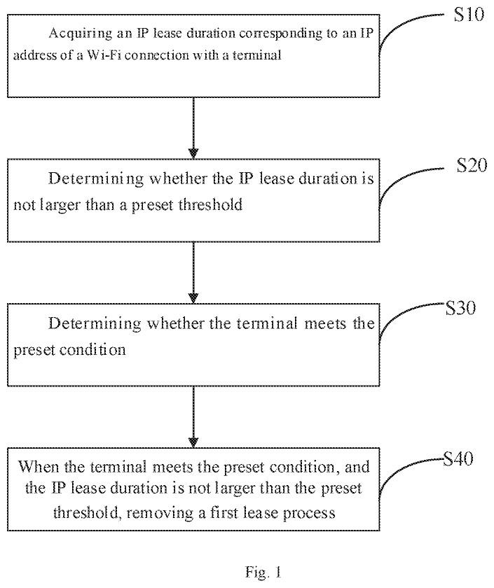

Referring to FIG. 1, FIG. 1 is a flow schematic view of a smart power saving method for a terminal according to an embodiment of the present disclosure, the method including operations at blocks illustrated in FIG. 1.

At block S10: an IP lease duration corresponding to an IP address of a Wi-Fi connection with the terminal is required.

Alternatively, the IP address of the Wi-Fi connection with the terminal is acquired, and the IP lease duration corresponding to the IP address of the current Wi-Fi connection is acquired.

Alternatively, in an embodiment, the IP address is a dynamic address automatically allocated by a router. In the operation of block S10, the IP address and the IP lease duration corresponding to the IP address are acquired from the router through a DHCP (Dynamic Host Configuration Protocol).

In an embodiment, when the terminal is connected to the IP address through Wi-Fi for the first time, the IP address of the current Wi-Fi connection with the terminal is recorded, and the IP lease duration corresponding to the IP address of the Wi-Fi connection with the terminal is acquired.

Alternatively, the IP lease duration refers to a dynamic IP address interval time automatically allocated to the terminal by the router connected with the terminal. The IP lease duration may vary according to a brand of the router and an initial lease duration, and the lease duration may be adjusted and configured according to user's needs.

At block S20: whether the IP lease duration is not larger than a preset threshold, is determined.

Alternatively, the IP lease duration acquired in the operation of block S10 is compared with the preset threshold to determine whether the IP lease duration is not larger than the preset threshold. Units of the acquired IP lease duration and those of the preset threshold are hours or minutes. When the units of the acquired IP lease duration is inconsistent with those of the preset threshold, the time units may be converted automatically. Such that the time units of the IP lease duration acquired in the operation of block S10 and those of the preset threshold may be consistent after a conversion, and may be compared with each other.

In an embodiment, the units of the IP lease duration acquired in the operation of block S10 and those of the preset threshold are both hours. The IP lease duration acquired in the operation of block S10 is directly compared with the preset threshold.

In another embodiment, the units of the IP lease duration acquired in the operation of block S10 is inconsistent with those of the preset threshold. The units of the acquired duration and those of the preset threshold may be converted according to a mathematical conversion rule between the two units before the comparison. Such that the units of the acquired duration and those of the preset threshold are consistent after the conversion, and the IP duration acquired in the operation of block S10 may be compared with the preset threshold.

Alternatively, in an embodiment, the units of the preset threshold may be configured to be consistent with those of the acquired IP lease duration, or the units of the preset threshold may be directly configured to be consistent with the initially configured time units of the acquired IP lease duration (consistent with the units of IP lease duration configured by a factory of the router).

Alternatively, a preset threshold range corresponding to the lease duration may be an any value in 6-10 hours, and may be specifically configured and adjusted according to user's needs.

In an embodiment, the preset threshold is configured to 6 hours according to empirical values, and the IP lease duration acquired in the operation of S10 is compared with the preset threshold of 6 hours.

In another embodiment, the preset threshold is configured to 8 hours according to empirical values.

In another embodiment, the preset threshold is configured to 9 hours according to empirical values.

In another embodiment, the preset threshold is configured to a value of less than 6 hours or more than 10 hours according to user's needs. The preset threshold may be configured specifically according to the user's needs, and is not limited here.

At block S30: whether the terminal meets a preset condition, is determined.

Alternatively, in the operation of block S30, whether a state of the terminal meets the preset condition is determined.

Alternatively, the preset condition includes: a screen-off state or a CPU sleep state. The screen-off state means that a terminal screen is in a black-out state, the CPU sleep state means that the terminal screen is in the black-out state, and a program and a software in the terminal stops running.

Alternatively, in an embodiment, in the operation of block S30, whether the terminal meets the preset condition is determined That is, whether the terminal is in the screen-off state or the CPU of the terminal is in the sleep state, is determined. In the operation of block S30, whether the screen of the terminal is in the screen-off state, or whether the screen of the terminal is in the screen-off state and the program and the software of the terminal are in a stopped state, is determined.

In another embodiment, the preset condition is configured that the CPU of the terminal is in the sleep state, that is, the screen of the terminal is in the black-out state and the program or the software of the terminal is stopped.

In another embodiment, the preset condition is configured that the screen of the terminal is in the black-out state or the CPU of the terminal is in the sleep state. When the screen of the terminal is in the black-out state, the terminal may be determined to meet the preset condition. When the CPU of the terminal is in the sleep state, the terminal may also be determined to meet the preset condition.

Alternatively, in the operation of block S30, a procedure of the determination of whether the screen of the terminal is in the screen-off state specifically includes: receiving a preset command information from the CPU, and determining whether the terminal is in the screen-off state or whether the CPU enters the sleep state according to the received preset command information.

Alternatively, the preset command information from the CPU refers to a command configured by the system to notify a corresponding monitoring module or an application of the current state of the terminal, when the terminal screen is in the black-out state or when the terminal CPU enters the sleep state.

Alternatively, in an embodiment, when the systems configured by the terminals are different, the commands from the CPUs are different from system to system. When the systems are implemented in different ways, for example, when an LCD screen turns off/lights up, the way of notifying the systems, and the commands configured by the system to notify the module or the application of the current state of the CPU and the LCD screen are different. The specific commands are determined according to an initial configuration of the system.

At block S40: when the terminal meets the predetermined condition, and when the IP lease duration is not larger than the preset threshold, a first lease process is removed.

Alternatively, when a result of the determination in the operation of block S30 is YES, and when the IP lease duration in the operation of block S20 is not larger than the preset threshold, the first lease process is removed.

In an embodiment, when in the operation of block S30 the terminal is determined to be in the screen-off state or the CPU of the terminal is determined to be in the sleep state, and the IP lease duration is determined not to be larger than the preset threshold, the first lease process is removed.

Alternatively, in an embodiment, after the operation of removing the first lease process, an operation further includes: renewing the IP address through the second lease process by an LAN (local area network) protocol.

In an embodiment, after the first lease process is removed, the IP address is renewed through the second lease process after the first lease process by the LAN protocol. According to the DHCP specification, the terminal must renew the lease of the IP address at regular intervals. During the renewal process, a Wi-Fi chip and an application processor (AP processor) may be woken up. Therefore, when the first lease process is removed, the IP address may be renewed through the second lease process, such that the Wi-Fi chip and the AP processor may be woken up only once in a lease period, effectively reducing a sum of a wake-up time of the Wi-Fi chip and the AP processor and that of the screen, reducing a power consumption and increasing an endurance time.

Alternatively, an operation of removing the first lease process specifically includes not waking up the Wi-Fi chip and the AP processor. At the same time when the Wi-Fi chip and AP processor are not woken up, the screen is not woken up. Such that the wake-up time of the Wi-Fi chip and AP processor and that of the terminal screen may be reduced, thereby effectively reducing the power consumption, saving an electricity, increasing the endurance time of the terminal, and thus providing a better user experience. The specific process of removing the Renew process may also include other forms of action commands, depending on the initial configuration.

The above method may effectively reduce the power consumption of the terminal by determining the IP lease duration corresponding to the IP address acquired by the terminal and determining the current state of the terminal, that is, determining whether the terminal is in the screen-off state or the CPU sleep state.

Alternatively, when in the operation of S30 the terminal is determined not to meet the preset condition, the lease renewal of the IP address may be performed through the first lease process. When the renewal of the IP address through the first lease process fails, the lease may wait to be renewed through the second lease process until the lease duration expires.

In an embodiment, when in the operation of block S30 the screen of the terminal is determined not to be in the screen-off state and the CPU of the terminal is determined not to be in the sleep state, the lease renewal of the IP address is performed through the first lease process. When the lease renewal of the IP address through the first lease process fails, the lease may wait to be renewed through the second lease process until the lease duration expires.

In another embodiment, when the preset condition in the operation of block S30 is initially configured that the CPU of the terminal is in the sleep state, under the configuration of the current preset condition, when the terminal is in the screen-off state but the CPU is not in the sleep state, the terminal is still determined not to meet the preset condition. At this time, the lease renewal of the IP address is first performed through the first lease process. When the renewal of the IP address through the first lease process fails, the IP address may wait to be renewed through the second lease process until the lease duration expires.

Alternatively, after the first lease process is removed, an operation further includes: renewing the IP address through the second lease process by the LAN protocol. Wherein the first lease process precedes the second lease process, and a time point of the first lease process is any time point in the lease duration, and the time point of the second lease process is the time point when the lease duration ends.

Alternatively, in an embodiment, the first lease process includes a Renew process and the second lease process includes a Rebind process.

Alternatively, in an embodiment, when in the operation of block S30 the terminal is determined to meet the preset condition and the IP lease duration is determined not to be larger than the preset threshold, the Renew process is removed. That is, the Wi-Fi and the AP processor may not be woken up, and the lease may wait to be renewed through the Rebind process until the lease duration expires.

Alternatively, in another embodiment, when in the operation of block S30 the terminal is determined not to meet the preset condition, the renewal of the IP address is performed by the Renewal process. When the IP address is successfully renewed through the renewal process, the smart power saving method for the terminal described in the operations of block S10 to block S40 is recycled again according to the preset configuration. When the terminal is connected to the same IP address, whether the operations of block S10 and block S20 are repeated multiple times is determined according to the preset configuration. When the IP address is not changed and the lease duration is not changed (or not changed for many times), an information stored in the previous lease renewal process may also be called, thus omitting the operations of block S10 and block S20 and further improving a real-time performance.

Alternatively, in another embodiment, when in the operation of block S30 the terminal is determined not to meet the preset condition, the renewal of the IP address is first performed through the Renew process. In response to the Renew process failing to renew the IP address, the IP address may wait to be renewed through the Rebind process until the lease duration expires.

Alternatively, in other embodiments, when in the operation of block S30 the terminal is determined to meet the preset condition, but when in the operation of block S20 the lease duration is determined to be greater than the preset threshold, the lease renewal of the IP address may still be performed through the first lease process. When the lease renewal of the IP address through the first lease process fails, the lease may wait to be renewed through the second lease process until the lease duration expires.

Alternatively, in the operation of block S10, before the IP lease duration corresponding to the IP address of the Wi-Fi connection with the terminal is acquired, an operation further includes: connecting to a Wi-Fi network.

In an embodiment, the terminal connects to the Wi-Fi network before the IP lease duration corresponding to the IP address of the Wi-Fi connection with the terminal is acquired in the operation of block S10. When the terminal is already connected to the Wi-Fi network, the terminal may be reconnected to the Wi-Fi network again, or check a network connection state of the terminal before the IP lease duration corresponding to the IP address of the Wi-Fi connection with the terminal is acquired in the operation of block S10.

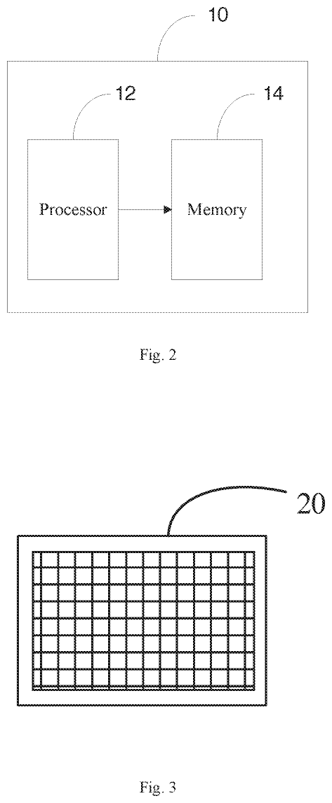

Referring to FIG. 2, FIG. 2 is a structural schematic view of a terminal 10 according to an embodiment of the present disclosure.

Alternatively, the terminal 10 according to the present disclosure includes a processor 12 and a memory 14 electrically connected to the processor. The processor 12 executes the smart power saving method for the terminal during the operation, and the memory 14 stores a result of the operation executed by the processor 12 and a program data corresponding to the smart power saving method for the terminal.

In an embodiment, the terminal 10 may be a mobile phone, a notebook computer, a tablet computer with communication and networking function, other computers that may be connected to the Wi-Fi based on the DHCP, or a wearable device with communication and networking function, but is not limited thereto.

Referring to FIG. 3, FIG. 3 is a structural schematic view of a device 20 having a memory function according to an embodiment of the present disclosure. The memory device 20 stores the program data. When the program data stored in the memory device is executed, the smart power saving method for the terminal is performed. Specifically, the memory device 20 may be one of the following: a memory of a terminal device, a personal computer, a server, a network device, a flash drive and the like.

According to the above scheme, the IP address of the Wi-Fi connection with the terminal and the corresponding IP lease duration are acquired. The acquired IP lease duration is compared with the preset threshold, whether the acquired IP lease duration is not larger than the preset threshold is determined, and whether the terminal meets the preset condition is determined at the same time. When the acquired IP lease duration is not larger than the preset threshold and the terminal meets the preset condition, the renewal process of the first lease process is removed, and the IP address may wait to be renewed through the second lease process. The above scheme may effectively reduce the wake-up time of the Wi-Fi and the AP processor and that of the terminal screen, effectively reducing the power consumption of the terminal and increasing the endurance time.

The above description is for the purpose of illustrating implementations of the present disclosure, but not to limit the scope of the present disclosure. Any equivalent structural or process transformation performed based on the drawings and the specification of the present disclosure, applied directly and indirectly in other related art, should be within the scope of the present disclosure.

What is claimed is:

1. A smart power saving method for a terminal, comprising:
acquiring an IP lease duration corresponding to an IP address of a Wi-Fi connection with the terminal;
determining whether the IP lease duration is not larger than a preset threshold;
determining whether a screen of the terminal is in a screen-off state or whether a CPU of the terminal is in a sleep state;
removing a first lease process, when the screen of the terminal is in the screen-off state or the CPU of the terminal is in the sleep state, and the IP lease duration is not larger than the preset threshold.

2. The smart power saving method for the terminal according to claim 1, wherein the determining whether the screen of the terminal is in the screen-off state comprises:
receiving a preset command information from the CPU;
the determining whether the screen of the terminal is in the screen-off state or whether the CPU of the terminal is in the sleep state, according to the preset command information.

3. The smart power saving method for the terminal according to claim 1, wherein the removing the first lease process further comprises: renewing the IP address by an local area network protocol through a second lease process, wherein the first lease process precedes the second lease process, a time point of the first lease process is any time point in the lease duration, and the time point of the second lease process is the time point when the lease duration ends;
the first lease process comprises a Renew process; the second lease process comprises a Rebind process.

4. The smart power saving method for the terminal according to claim 1, wherein when the screen of the terminal is not in the screen-off state and the CPU of the terminal is not in the sleep state, or when the IP lease duration is larger than the preset threshold, the lease renewal of the IP address is first performed through the first lease process: when the renewal of the IP address through the first lease process fails, the lease waits to be renewed through a second lease process until the lease duration expires.

5. The smart power saving method for the terminal according to claim 1, wherein the acquiring the IP lease duration corresponding to the IP address of the Wi-Fi connection with the terminal further comprises: connecting to a Wi-Fi network.

6. The smart power saving method for the terminal according to claim 1, wherein a threshold range corresponding to the lease duration is any value in 6-10 hours.

7. The smart power saving method for the terminal according to claim 1, wherein the removing the first lease process comprises not waking up the Wi-Fi and an application processor.

8. A terminal, comprising a processor and a memory electrically connected to the processor, wherein a smart power saving method for a terminal is executed when the processor is in operation, the memory stores an execution result of the processor and a program data of the smart power saving method for the terminal, and the smart power saving method for the terminal comprises:
acquiring an IP lease duration corresponding to an IP address of a Wi-Fi connection with the terminal;
determining whether the IP lease duration is not larger than a preset threshold;
determining whether the terminal meets a preset condition;
removing a first lease process, when the terminal meets the preset condition, and the IP lease duration is not larger than the preset threshold.

9. The terminal according to claim 8, wherein the preset condition is a screen-off state or a CPU sleep state.

10. The terminal according to claim 9, wherein the determining whether the screen of the terminal is in the screen-off state comprises:
receiving a preset command information from the CPU;
the determining whether the screen of the terminal is in the screen-off state or whether the CPU of the terminal is in the sleep state, according to the preset command information.

11. The terminal according to claim 8, wherein the removing the first lease process further comprises: renewing the IP address by an local area network protocol through a second lease process, wherein the first lease process precedes the second lease process, a time point of the first lease process is any time point in the lease duration, and the time point of the second lease process is the time point when the lease duration ends;
the first lease process comprises a Renew process; the second lease process comprises a Rebind process.

12. The terminal according to claim 8, wherein when the terminal does not meet the preset condition, or when the IP lease duration is larger than the preset threshold, the lease renewal of the IP address is first performed through the first lease process: when the renewal of the IP address through the first lease process fails, the lease waits to be renewed through a second lease process until the lease duration expires.

13. The terminal according to claim 8, wherein the acquiring the IP lease duration corresponding to the IP address of the Wi-Fi connection with the terminal further comprises: connecting to a Wi-Fi network.

14. The terminal according to claim 8, wherein a threshold range corresponding to the lease duration is any value in 6-10 hours.

15. The terminal according to claim 8, wherein the removing the first lease process comprises not waking up the Wi-Fi and an application processor.

16. A device with a memory function, wherein the memory device stores a program data, a smart power saving method for a terminal is performed when the program data is executed, the smart power saving method for the terminal comprises:
acquiring an IP lease duration corresponding to an IP address of a Wi-Fi connection with the terminal;
determining whether the IP lease duration is not larger than a preset threshold;
determining whether the terminal meets a preset condition;
removing the first lease process, when the terminal meets the preset condition, and the IP lease duration is not larger than the preset threshold.

17. The device according to claim 16, wherein the preset condition is a screen-off state or a CPU sleep state.

18. The device according to claim 17, wherein the determining whether the screen of the terminal is in the screen-off state comprises:
receiving a preset command information from the CPU;
the determining whether the screen of the terminal is in the screen-off state or whether the CPU of the terminal is in the sleep state, according to the preset command information.

19. The device according to claim 16, wherein the removing the first lease process further comprises: renewing the IP address by an local area network protocol through a second lease process, wherein the first lease process precedes the second lease process, a time point of the first lease process is any time point in the lease duration, and the time point of the second lease process is the time point when the lease duration ends;
the first lease process comprises a Renew process: the second lease process comprises a Rebind process.

20. The device according to claim 16, wherein when the terminal does not meet the preset condition, or when the IP lease duration is larger than the preset threshold, the lease renewal of the IP address is first performed through the first lease process; when the renewal of the IP address through the first lease process fails, the lease waits to be renewed through a second lease process until the lease duration expires.
